(19) United States
(12) Patent Application Publication
(10) Pub. No.: US 2009/0295846 A1
(43) Pub. Date: Dec. 3, 2009

(54) Method and system for applying a visible identification to transparent substrates

(76) Inventor: Gerold Simke, Bischofswerda (DE)

Correspondence Address: COLLARD & ROE, P.C., 1077 NORTHERN BOULEVARD, ROSLYN, NY, 11576, US

(21) Appl. No.: 11/919,902

(22) PCT Filed: May 4, 2006
(86) PCT No.: PCT/DE2006/000773

§ 371 Date: Dec. 12, 2007

(30) Foreign Application Priority Data
May 6, 2005 (DE) 10 2005 021 654.4

(51) Int. Cl. B41J 3/00; B41J 2/01; B41J 2/07; B41J 2/125

(52) U.S. Cl. 347/2; 347/1; 347/100; 347/102; 347/9

(57) ABSTRACT

The invention relates to a method and a system for applying a visible identification to transparent substrates, whereby the substrate is subjected to light radiation and micro-engravings on the spectacle lens are optically detected and the coordinates thereof are determined and a pattern from a print material is applied to the surface of the transparent substrate relative to the position of the micro-engraving. The aim of the invention is to increase the flexibility of printing of transparent substrates and to reduce the technological complexity. For this purpose, the pattern is applied by means of an ink jet method from an ethanol-containing ink as the print material and the transparent substrate is heated and/or the light radiation is carried out in a wavelength range outside of the transmission range of the substrate, i.e. in a range in which the substrate no longer appears transparent.

The invention relates to a method for applying a visible identification to transparent substrates, in which a pattern of a printing material is applied to the surface.

The invention also relates to a system for applying a visible identification to transparent substrates, having a transport device for the substrates and a print head that can be positioned relative to the surface of the substrate to be imprinted.

Eyeglass lenses, particularly progressive lenses, are provided with permanent engravings by the manufacturer. These permanent engravings serve to identify the location of the lens characteristics on the eyeglass lens, in each instance. For this purpose, small symbols are engraved into the surface of the progressive lens, by means of a mechanical method or a laser engraving method. A circle shape or the shape of a reclining eight is known as the shape of these symbols. Circular symbols have a diameter of 1 to 2 mm, in most cases. They lie at a distance from the center of the eyeglass lens, particularly at a distance of 17 mm on both sides, in each instance. Thus, the center is defined by these two points, as well as by a 180° line, which shows the horizontal position of the of the lens characteristics.

Thus, all of the essential coordinates of the eyeglass lens that the optician who later places the eyeglass lens into the eyeglasses needs, in order to place the eyeglass lens into the eyeglasses in the correct position can be derived.

Furthermore, additional data are also engraved into the surface of the eyeglass lens, by means of micro-engraving, in most cases, such as an identification of the near vision region, an indication of the addition, the fitting cross, its distance from the 1800 line, manufacturer-specific or customer-specific information, logos, etc.

International ophthalmic standards such as the OMA protocol are available for the engraving and the design.

The micro-engravings are structured to be so thin, with such thin lines, that they are difficult to see on the eyeglass lens later, when it is in the eyeglasses. For this reason, the data that are essential to the optician are made visible in that the eyeglass lens is provided with an additional, clearly visible imprint at the corresponding markings, particularly at the permanent engravings.

For this purpose, printing devices, such as the Teco TP 1, Teco TP 2, Teco TP2V systems, or the Multi DV8 printing machine, all from the company COTEC GmbH, 61130 Nidderau, are known, are known, which are included in the technological sequence of steps. In this connection, the eyeglass lenses move through production on a transport belt, in transport bowls. For imprinting, they are removed from the transport belt and introduced into the printing device. In this device, there is a measurement station by means of which the position of the micro-engravings is determined using the transmitted light method. In the transmitted light method, a light source is now disposed on the one side, and an optical image-recording unit that is connected with an image-recognition unit is disposed on the other side of the eyeglass lens.

The coordinates of the micro-engravings are determined by means of the image-recognition unit, and the eyeglass is positioned in the printing station in the correct position. Subsequently, imprinting of the eyeglass lens takes place at the locations provided, by means of a dabber printing method.

Dabber printing is an indirect printing method (intaglio printing principle). A printing plate carries the recessed print image to be printed in its surface. This print image is filled with printing ink, in that a doctor pushes the ink into the recessed print image, and cleanly wipes the excess ink off in doing so. After doctoring, an elastic print dabber is passed over the plate and picks up the ink, and then transfers the ink to the object to be imprinted, in other words prints indirectly.

Because of the deformability of the dabber, imprinting of domed surfaces (convex or concave) is easily possible. Because of its elasticity, the dabber assumes the shape of the body to be imprinted, and thus it can transfer the motif to the object to be imprinted.

The printing plates used in this dabber printing method have pre-defined patterns. For one thing, this makes printing less flexible with regard to a selection of the print image, and possible only in one color. For another, it is disadvantageous that the eyeglass lenses must be removed from the transport bowls for imprinting, and subsequently placed in them again. This causes additional handling effort.

It is possible to imprint other transparent substrates, such as display panes, lenses, watch crystals, and many more, using similar printing devices.

Inkjet printers that function according to the continuous inkjet principle (so-called CIJ printers) are also known, for example from EP 362 101. These are used in various sectors (e.g. scratch-off lottery tickets, use-by date, EAN code, addressing, personalization, etc.). In a CIJ printer, the inkjet exits from the print head by way of a nozzle or several nozzles. This jet is modulated and thereby broken up into individual droplets, in the end. The droplets formed in this manner can now be charged by way of a charging electrode, and subsequently be deflected by way of another electrode. Depending on the type of device, the charged or uncharged droplets, respectively, now reach the substrate/product. As described in EP 9 365 454, droplets that are not needed are already captured at the print head and passed back into the ink circulation.

Such printers are used in the case of objects to be imprinted, where the ink immediately enters into a connection with the surface of the object, in other words absorbent surfaces, for example. Transparent substrates, in other words glass substrates or substrates of hardened plastic, for example, do not have this property, however, and therefore imprinting by means of the dabber printing method was always selected according to the state of the art.

The CIJ method according to the state of the art is also not suitable for printing precise identifications onto uneven surfaces, such as the surfaces of eyeglass lenses, since in this connection, the droplets are deflected by a greater or lesser angle. Therefore distortions in the print image occur in the case of curved surfaces, and this must be precluded in the case of precision print images.

The invention is therefore based on the task of increasing the flexibility in connection with imprinting transparent substrates, and reducing the technological effort.

On the method side, this task is accomplished by means of a method having the characteristics of claim 1. Advantageous embodiments of this method are contained in the dependent claims 1 to 23.

Accordingly, it is provided that the pattern is applied by means of an inkjet method, using an ink as the printing material. The inkjet method allows imprinting without keeping different printing plates on hand, and is significantly more flexible in use.

In a preferred variant, the printing material is applied in the form of an ink that contains ethanol. It has been shown that an ink that contains ethanol has better wetting properties on a transparent substrate, particularly a glass substrate, on the one hand, and that on the other hand, the solvent in this ink evaporates rapidly, so that the ink solidifies quickly on the substrate, although the substrate itself does not possess any absorbent properties.

According to the known state of the art, imprinting by means of inkjet, particularly on anti-reflective surfaces of transparent substances, was unsuccessful until now because of their hydrophobic and hydrophilic behavior with regard to droplets of liquid. The ink that contains ethanol overcomes this difficulty, for one thing. The ink solidifies very rapidly by means of heating of the substrate, thereby to label a transparent substrate, particularly one having an anti-reflective surface, in freely programmable manner.

By means of heating before imprinting or during imprinting, the ink already arrives on a pre-heated substrate and solidifies immediately. Heating therefore also represents a kind of adhesion promotion between ink and substrate surface.

It is also possible, in addition or alternatively, that the substrate is heated after imprinting. In this way, the solidification process of the ink, which is essentially based on drying, i.e. evaporation of the solvent, is accelerated after production of the ink particles on the substrate.

One possibility consists in irradiating the substrate by means of infrared radiation in order to heat it. This has the advantage that the heat source is disposed at a distance from the substrate. Since a transparent substrate absorbs relatively little radiation, heating takes place, in particular, partially in the region of the ink particles, so that any temperature stress on the substrate can be kept low.

Alternatively to this, the substrate can be exposed to a hot-air stream in order to heat it. This can be advantageous in the case of specific materials of the transparent substrates, for example in the case of glass, because in this way, the entire substrate is heated evenly and therefore stresses can be avoided. Furthermore, the drying effect is improved.

Another possibility consists in applying the pattern in multiple colors. Since the pattern consists of individual ink particles, as described above, these can also consist of ink of different colors. Since these ink particles are very small, it is possible, in this connection, to make different colors appear by means of optical color mixing, in that ink particles of different colors, composed of the basic colors of subtractive color mixing, are disposed next to one another.

Furthermore, ink particles having the same or different color can be set closely next to one another by means of the method. This is of significance for the production of optical color mixtures and for the production of closed surfaces. In this connection, in a first printing process the raster width is selected in such a manner that the ink particles do not run into one another. After a drying step of 2 s, for example, additional ink particles are applied into the interstices. This step can be repeated multiple times, until the desired density of the dot raster is achieved. Thus, better printing results can be achieved at the edge of the pattern, as well.

This is taken into consideration in an embodiment of the method in which the printing process is carried out in a first step, whereby a first pattern is applied with an ink in a first color, and afterwards, the process is carried out in a second step, whereby a second pattern is applied with an ink in a second color, whereby the first and the second ink and/or the first and the second pattern are different, in each instance.

As explained above, tiny ink droplets are thrown onto the substrate by means of inkjet printing (inkjet printing), from a nozzle or several nozzles of an inkjet print head. There, they produce a small ink particle. Patterns can be produced on the substrate by means of multiple ink particles set next to one another, for example lines or large-area patterns. In this connection, the print head is moved relative to the substrate in order to produce the pattern.

In this connection, the droplets are thrown over relatively great distances, so that the substrate does not necessarily have to be planar, and imprinting of curved or domed substrate surfaces is also possible.

In the case of domed surfaces, different distances between substrate surface and print head occur due to the relative movement between print head and substrate. To increase the precision of the print image, it is therefore proposed, according to the invention, to guide the print head to follow the substrate surface essentially in the acceleration direction of the inkjet or the ink droplets, i.e. perpendicular to the direction of the relative movement between substrate and print head. This can be done with a second relative movement between substrate and print head, by means of which the distance between print head and substrate surface is kept essentially constant during the first relative movement.

In the case of imprinting of domed substrates, the precision of the print image can also be improved by means of a targeted distortion. Since the print image is composed of ink droplets separated from an inkjet by means of an electrostatic influence, different path lengths occur in the case of a domed substrate, at different deflection angles. To state it more precisely, the ink droplets are deflected in a direction that essentially perpendicular to the printing direction, in other words the movement direction of the relative movement between substrate and print head. As a result, distortions of the print image occur on domed substrates, in comparison with a print image such as it would be printed on a planar substrate, particularly in the case of great deflection of the ink droplets from the center line. The idea according to the invention now consists in distorting the print image for the domed substrate, as compared with a planar substrate, in such a manner that when the print image appears on the domed substrate, are eliminated.

Since the print image is produced by way of electronic control in the print head, the targeted distortion occurs by way of control of the print head. In this connection, it is practical to configure the control in such a manner that imaginary grid network lines of the pattern to be printed are already distorted in the control program. Since the pattern changes during printing occurs by means of the deflection of the ink droplets that takes place crosswise to the printing direction, the distortion of the print image will also take place essentially crosswise to the printing direction. To put it differently, imaginary grid network lines that lie in the printing direction are bent when the pattern is imprinted onto domed substrates, in comparison with printing on planar substrates. The process now “bends” these grid network lines, counter to their distortion tendency, already before printing takes place, so that a linear print image is formed during printing.

It has proven to be particularly practical, in this connection, to deform the grid network lines that run in the printing direction on both sides of the center line, in other words in biconcave manner, when printing onto a concave substrate. When printing on convex substrates, it has proven to be practical to perform this deformation in biconvex manner on both sides of the imaginary center line. In this connection, biconcave is meant to be understood as a spherical spreading of the grid network lines in relationship to a center grid network line. Vice versa, biconvex is supposed to be understood as a spherical bringing of the outer grid network lines towards a center grid network line.

In particular, the method according to the invention is conceived for use for eyeglass lenses, whereby the pattern is applied to an eyeglass lens as a substrate, and whereby micro-engravings on the eyeglass lens are optically detected and their coordinates are determined, and the pattern is applied relative to the position of the micro-engraving.

In another embodiment, it is provided that the eyeglass lens is transported on a transport belt and the pattern is applied to the eyeglass lens situated on the transport belt. From this, it becomes evident that the technological sequence of steps in production does not have to be disturbed.

In another advantageous embodiment of the invention, it is provided to bias the substrate with an electrostatic charge having a polarity opposite an electrostatic bias of the inkjet.

In this way, the energy with which the ink droplets impact on the substrate can be increased, and this improves the adhesion, particularly in the case of hydrophobic (water-repelling) layers.

The printing method can also be used in order to facilitate finding micro-engravings on transparent substrates. In this connection, it is particularly advantageous that light radiation is applied to the substrate, and thereby micro-engravings on the eyeglass lens are optically detected, and their coordinates are determined, and the pattern is applied relative to the position of the micro-engraving. In this connection, the wavelength of the light radiation can lie in the wavelength range of visible light. On the other hand, it has proven to be practical to place the light radiation into a wavelength range outside of the transmission range of the substrate, i.e. for which the substrate no longer appears transparent.

In this wavelength range, in which the substrate is no longer transparent, the recognizability of the micro-engravings is thereby significantly improved.

It is thereby possible for the wavelength range of the light radiation to lie above or below the transmission range of the substrate.

Here, it is advantageous that the substrate is illuminated with an infrared light source, the radiation maximum of which lies in the wavelength range above 700 nm.

Alternatively to this, it can be provided that the substrate is illuminated with an ultraviolet light source, the radiation maximum of which lies in the wavelength range below 400 nm.

By means of selecting the illumination wavelength, it becomes possible for detection of the micro-engraving to be carried out using the reflected light method. As a result, in turn, it is no longer necessary to take the transparent substrates out of the transport bowl (tray) or off the transport belt, thereby eliminating an additional handling step and improving the efficacy of production.

On the system side, the task is accomplished by means of a system having the characteristics of claim 24. Corresponding embodiments are contained in the dependent claims 25 to 41.

In this connection, it is provided that the print head is configured as an inkjet print head, and a heating device for heating the substrate is disposed. The inkjet head can serve for inkjet printing on transparent substrates in connection with the heating device, since adhesion on the substrate surface is made possible by means of the heating device.

The possibility exists of being able to pivot the print head above the transport device. Therefore the substrate no longer has to be taken out of the transport device for the purpose of printing, and this in turn serves to increase the efficacy.

The possibility exists of disposing the heating device ahead of or behind the print head in the transport direction. In this way, either pre-heating or subsequent heating for the purpose of drying the ink is possible.

The heating device can consist of an infrared radiator that is disposed above the substrate, with its beam direction aimed at the substrate. This radiator hinders a transport device as little as the alternative, in which the heating device consists of a hot-air blower, whose hot-air outlet is disposed above the substrate, with its jet direction aimed at the substrate.

To the extent that micro-engravings have to be recognized on the substrate in order to position the print pattern, it is very advantageous that a light source and a measurement station consisting of an optical image-recording unit and image-recognition unit are disposed for determining the position of micro-engravings, the light source is configured as an ultraviolet or infrared light source.

This light source can consist of a mercury vapor lamp, particularly with main lines at 300 nm, 313 nm, or 365 nm, or a xenon lamp, of a deuterium lamp, or of a UV laser beam source, particularly with main lines at 262 nm, 266 nm, 325 nm, 349 nm, or 355 nm.

Furthermore, it is advantageous that a filter is disposed between the substrate and the light source and/or between the substrate and the optical image-recording unit. This filter can be configured as a band-pass filter or edge filter, with a passage for infrared radiation or UV radiation.

To eliminate reflections, it is furthermore advantageous if the filter or an additional filter is configured as a polarization filter.

In an advantageous embodiment, it is provided that the light source is disposed on the side of the substrate on which the optical image-recording unit is also situated. In this way, a reflected light measurement is made possible, which avoids a transmitted light method, in which the substrates always have to be taken off a transport device.

A particularly good effect of the reflected light measurement is achieved if the beam direction of the light source and the optical axis of the optical image-recording unit enclose an angle whose angle bisector stands perpendicular or at an obtuse angle on the surface of the substrate.

In the following, the invention will be described in greater detail using an exemplary embodiment. In the related drawings, the figures show:

FIG. 1 a perspective view of a system according to the invention, with the image recognition unit pivoted in,

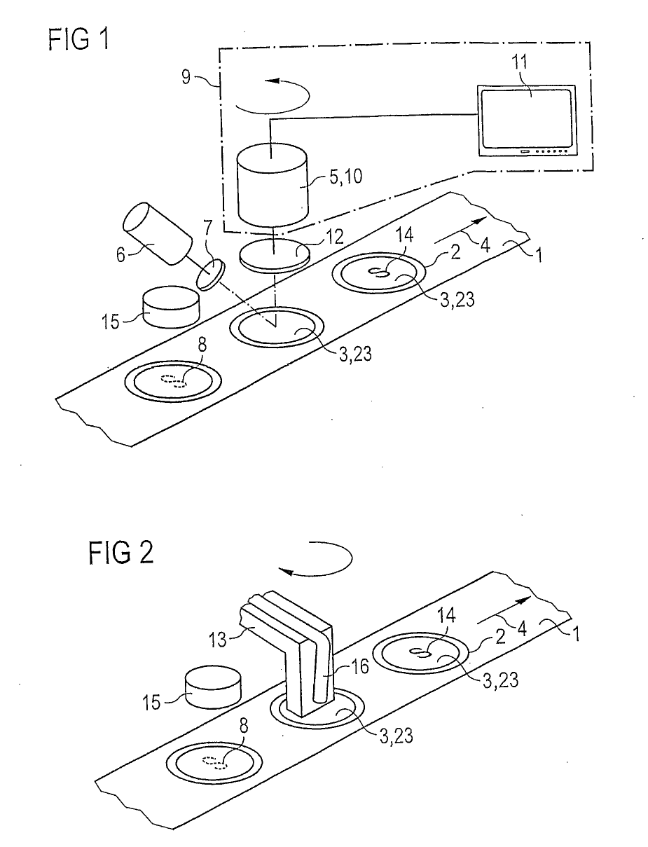

FIG. 2 a perspective view of a system according to the invention, with the print head pivoted in,

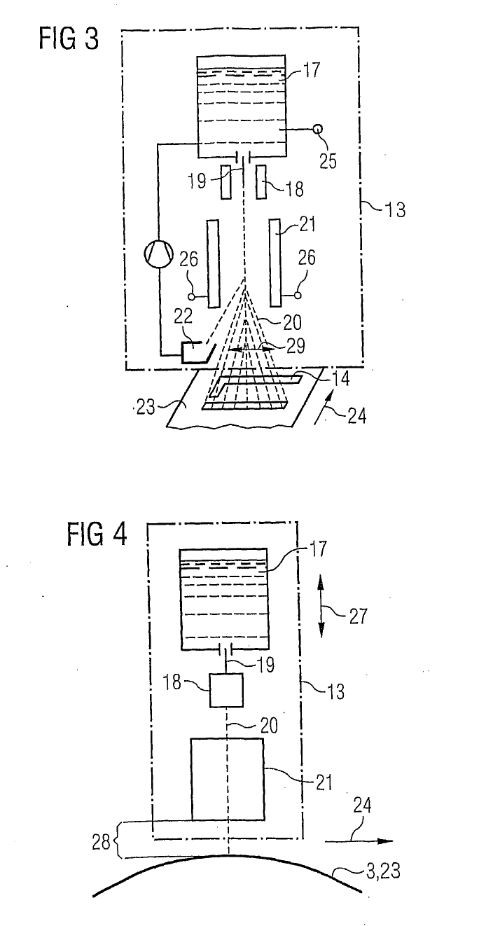

FIG. 3 a fundamental diagram of a print head system,

FIG. 4 a fundamental diagram of a print head guidance device in the case of a domed substrate, and

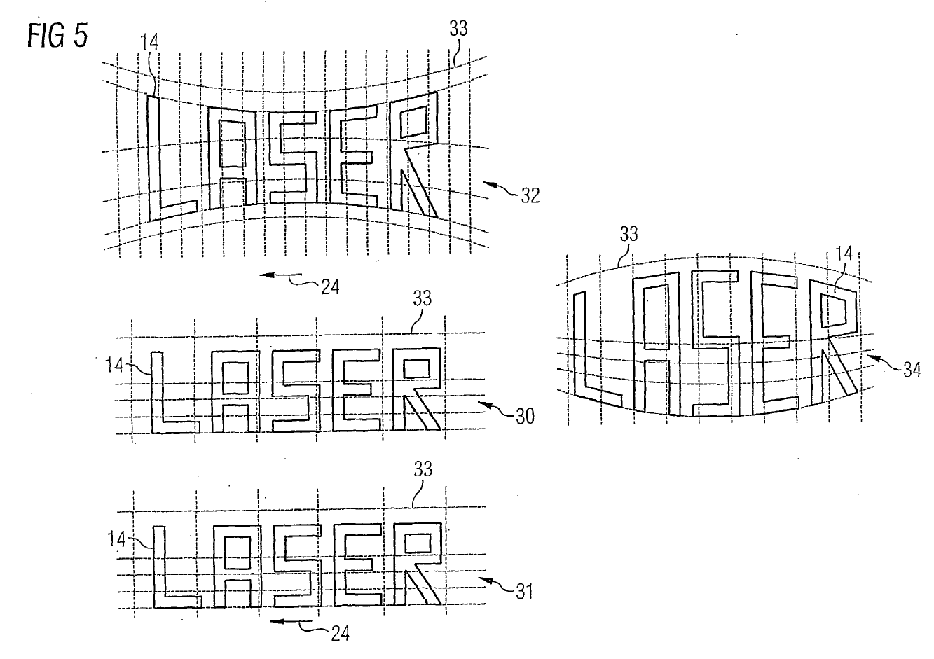

FIG. 5 a fundamental diagram of a targeted distortion of a print image for printing on a domed substrate, in relation to a planar substrate.

As shown in FIG. 1, transport bowls 2 are provided on a transport belt 1, which serve to accommodate eyeglass lenses 3 as substrates. The transport belt 1 is moved in a transport direction 4, until an eyeglass lens 3 lies underneath an optical image-recording unit 5 that is configured as a camera. There, the transport belt 1 is stopped. UV light is applied to the eyeglass lens 3 by way of a light source 6 that is configured as a UV lamp, by way of a UV filter 7. In this way, the visible light is filtered out and the eyeglass lens 3 no longer appears transparent. A micro-engraving 8 applied to the eyeglass lens 3 can therefore easily be recognized by the measurement station 9, which includes an image recognition unit 10 in the form of a camera and a monitor 11. A polarization filter 12 between the image recognition unit 10 and the eyeglass lens 3 filters out reflections and in doing so supports the improved recognizability of the micro-engraving 8.

After the position of the micro-engraving 8 has been recognized and its coordinates are therefore known, the image recognition unit 10 is pivoted away from its position above the transport belt 1.

Then a print head 13 is pivoted over the eyeglass lens 3. The print head has print nozzles, not shown in any detail, by means of which ink droplets that form a print pattern 14 are sprayed onto the eyeglass lens 3. Since the eyeglass lens 3 has already been pre-heated by means of a heating device 15 that consists of an infrared radiator, the ink adheres to the eyeglass lens 3 immediately. The print head 13 itself is provided with a hot-air blower 16, by means of which hot air is blown onto the eyeglass lens 3, so that the ink dries completely and enters into sufficiently firm adhesion to the eyeglass lens 3.

After imprinting, the transport belt 1 moves on, until the next of the eyeglass lenses 3 then comes to a stop underneath the image recognition unit 10, which has been pivoted in once again.

As shown in FIG. 3, the print head 13 consists of an ink tank 17, an atomization unit 18 in which individual ink droplets 20 are formed from an inkjet 19, and a deflection unit 21 for deflecting the ink droplets 20 and producing the print pattern 14.

To return the ink during pauses in printing, the print head is provided with a return device 22. As shown in FIG. 3, the print pattern 14 is produced by means of a movement of the substrate 23 relative to the print head 13, in a movement direction 24. For this purpose, the ink is biased with an electrostatic voltage, as is supposed to be made clear by means of the connector 25. In the deflection unit 21, a deflection of the ink droplets 20 is then produced by means of applying a voltage to the deflection system, as is made clear with the representation of the connectors 26, so that the pattern 14 is formed. The voltage at the connectors 26 is set by means of a computer, not shown in detail, which produces a voltage pattern from a reference pattern to be produced, by way of corresponding software, so that the print pattern 14 can form with the movement in the printing direction 24.

If domed substrates 23 are used, the print head 13 is subjected to a movement in a second direction 27 perpendicular to the first movement direction 24. In this way, the print head 13 is guided to follow the surface of the substrate 23, so that the distance 28 can be kept approximately constant. In this way, the print precision in the first movement direction 24, i.e. in the printing direction, can guaranteed.

To ensure the printing precision in the direction 29 of the deflection of the ink droplets 20, a targeted distortion of the print image is provided, as shown in FIG. 5. This distortion takes place by way of the software in the computer. When printing on planar surfaces, the voltage pattern at the connectors 26 is set, by means of computer technology, in such a manner that the reference pattern 30 is imaged in linear manner, as is shown with the print pattern 31 under the reference pattern 30. In a surface of the substrate 23 having convex curvature, as shown in FIG. 4, the reference pattern 30 would be imaged as a print pattern 32, as shown above the reference pattern 30, which has concave distortions of the grid network lines 33. In order to now avoid the distortions of the print pattern 32 and image the reference pattern 30 also on a convex surface of the substrate 23, like the print pattern 31, a voltage pattern is produced by the computer, at the connectors 26, which corresponds to a reference pattern 34 with a targeted, biconvex distortion of the grid network lines 33.

### REFERENCE SYMBOL LIST

1 transport belt
2 transport bowl
3 eyeglass lens
4 transport direction
5 optical image-recording unit
6 light source
7 UV filter
8 micro-engraving
9 measurement station
10 image recognition unit
11 monitor
12 polarization filter
13 print head
14 print pattern
15 heating device
16 hot air blower
17 ink tank
18 atomization unit
19 inkjet
20 ink droplet
21 deflection unit
22 return device
23 substrate
24 first movement direction
25 connector for ink bias
26 connector at the deflection unit
27 second movement direction
28 distance
29 deflection direction
30 reference pattern
31 print pattern on planar surface
32 print pattern on convex surface
33 grid network line
34 reference pattern with targeted distortion

1. Method for applying a visible identification to transparent substrates (23), in which a pattern (14) of a printing material is applied to the surface, wherein the pattern (14) is applied by means of an inkjet method, using an ink as the printing material.

2. Method according to claim 1, wherein an ink that contains ethanol is applied as the printing material.

3. Method according to claim 1, wherein the transparent substrate (23) is heated.

4. Method according to claim 1, wherein the substrate (23) is heated before or during imprinting.

5. Method according to claim 1, wherein the substrate (23) is heated after imprinting.

6. Method according to claim 1, wherein the substrate (23) is irradiated with infrared radiation in order to heat it.

7. Method according to claim 1, wherein the substrate (23) is exposed to a hot-air stream in order to heat it.

8. Method according to claim 1, wherein the pattern (14) is applied in multiple colors.

9. Method according to claim 1, wherein the printing process is carried out in a first step, whereby a first pattern is applied with an ink in a first color, and afterwards, the process is carried out in a second step, whereby a second pattern is applied with an ink in a second color, whereby the first and the second ink and/or the first and the second pattern are different, in each instance.

10. Method according to claim 1, wherein the pattern (14) is applied to a substrate (23) having a domed surface.

11. Method according to claim 10, wherein the pattern (14) is produced by means of a print head (13), in that ink droplets (20) are thrown onto the substrate (23) in an acceleration direction, and the print head (13) is moved over the substrate surface in a printing direction (24), whereby the print head (13) is guided to follow the substrate surface in terms of its distance (28) from it, in the acceleration direction.

12. Method according to claim 10, wherein the pattern (14) is applied by means of a movement of a print head (13) over the substrate surface, in a printing direction (24), onto a substrate (23) that is concave, viewed from the print head (13), whereby the print head (13) is controlled in such a manner that the pattern (34) experiences a distortion, in such a manner that imaginary grid network lines (33) of the pattern (34) are curved in biconcave manner in the printing direction (24), as compared with printing on a planar substrate surface.

13. Method according to claim 10, wherein the pattern (14) is applied by means of a movement of a print head (13) over the substrate surface in a printing direction (24), onto a substrate (23) that is convex, viewed from the print head (13), whereby the print head (13) is controlled in such a manner that the pattern (34) experiences a distortion, in such a manner that imaginary grid network lines (33) of the pattern are curved in biconvex manner in the printing direction (24), as compared with printing on a planar substrate surface.

14. Method according to claim 10, wherein the pattern (14) is applied to an eyeglass lens (3) as the substrate (23), whereby micro-engravings (8) are optically detected on the eyeglass lens (3) and their coordinates are determined, and the pattern (14) is applied relative to the position of the micro-engraving (8).

15. Method according to claim 10, wherein the eyeglass lens (3) is transported on a transport belt (1) and the pattern (14) is applied to an eyeglass lens (3) situated on the transport belt (1).

16. Method according to claim 1, wherein the substrate (23) is biased with an electrostatic voltage having a polarity opposite an electrostatic bias of the inkjet (19).

17. Method according to claim 1, wherein the substrate (23) has light radiation applied to it, and thereby micro-engravings (8) on the eyeglass lens (3) are optically detected, and their coordinates are determined, and the pattern (14) is applied relative to the position of the micro-engraving (8).

18. Method according to claim 17, wherein the light radiation lies in the wavelength range of visible light.

19. Method according to claim 17, wherein the light radiation takes place in a wavelength range outside of the transmission range of the substrate (23), i.e. for which the substrate (23) no longer appears transparent.

20. Method according to claim 19, wherein the wavelength range of the light radiation lies above or below the transmission range of the substrate (23).

21. Method according to claim 20, wherein the substrate (23) is illuminated with an infrared light source, the radiation maximum of which lies in the wavelength range above 700 nm.

22. Method according to claim 20, wherein the substrate (23) is illuminated with an ultraviolet light source, the radiation maximum of which lies in the wavelength range below 400 nm.

23. Method according to claim 17, wherein the detection of the micro-engraving (8) is carried out using the reflected light method.

24. System for applying a visible identification to transparent substrates (23), having a transport device (1) for the substrates (23) and having a print head (13) that can be positioned relative to the surface of the substrate (23) to be imprinted, wherein the print head (13) is configured as an inkjet print head.

25. System according to claim 24, wherein a heating device (15) for heating the substrate (23) is disposed.

26. System according to claim 24, wherein the print head (13) can be pivoted over the transport device (1).

27. System according to claim 26, wherein the heating device (15) is disposed ahead of or behind the print head (13), in the transport direction.

28. System according to claim 24, wherein the heating device (15) consists of an infrared radiator that is disposed above the substrate (23), with its beam direction aimed at the substrate (23).

29. System according to claim 24, wherein the heating device (15) consists of a hot-air blower (16) whose hot-air outlet is disposed above the substrate (23), with its jet direction aimed at the substrate (23).

30. System according to claim 1, wherein a light source (6) and a measurement station (9) consisting of an optical image-recording unit (5) and image-recognition unit (10) are disposed for determining the position of micro-engravings (8), and the light source is configured as an ultraviolet or infrared light source.

31. System according to claim 30, wherein the light source (6) consists of a mercury vapor lamp.

32. System according to claim 31, wherein the main lines lie at 300 nm, 313 nm, or 365 nm.

33. System according to claim 30, wherein the light source (6) consists of a xenon lamp.

34. System according to claim 30, wherein the light source (6) consists of a deuterium lamp.

35. System according to claim 30, wherein the light source (6) consists of a UV laser beam source.

36. System according to claim 35, wherein the main lines lie at 262 nm, 266 nm, 325 nm, 349 nm, or 355 nm.

37. System according to claim 30, wherein a filter (7) is disposed between the substrate (23) and the light source (6) and/or between the substrate (23) and the optical image-recording unit (5).

38. System according to claim 37, wherein the filter (7) is configured as a band-pass filter or edge filter, with a passage for infrared radiation or UV radiation.

39. System according to claim 37, wherein the filter (7) is configured as a polarization filter.

40. System according to claim 30, wherein the light source (6) is disposed on the side of the substrate (23) on which the optical image-recording unit (5) is also situated.

41. System according to claim 40, wherein the beam direction of the light source (6) and the optical axis of the optical image-recording unit (5) enclose an angle whose angle bisector stands perpendicular or at an obtuse angle on the surface of the substrate (23).
